(19) United States
(12) Patent Application Publication
(10) Pub. No.: US 2015/0023048 A1
(43) Pub. Date: Jan. 22, 2015

(54) APPARATUS AND METHOD FOR REDUCING LASER SPECKLE

(71) Applicant: NATIONAL YUNLIN UNIVERSITY OF SCIENCE AND TECHNOLOGY, Douliu City (TW)

(72) Inventors: Chien-Yue CHEN, Douliou City (TW); Qing-Long DENG, Taipei City (TW); Kuan-Yao CHIU, Douliu City (TW)

(73) Assignee: NATIONAL YUNLIN UNIVERSITY OF SCIENCE AND TECHNOLOGY, Douliu City (TW)

(21) Appl. No.: 13/946,868

(22) Filed: Jul. 19, 2013

(51) Int. Cl. G02B 27/48

(52) U.S. Cl. CPC G02B 27/48
USPC 362/553

(57) ABSTRACT

An apparatus for reducing laser speckle cooperates with a laser light source and comprises a light guide tube and a vibration element coupled on the light guide tube. The light guide tube includes an input member corresponding to the laser light source, an output member far away from the laser light source, and a chamber allowing a laser beam which is emitted by the laser light source to perform total reflection inside. The vibration element is arranged at a region between the input member and the output member to drive the light guide tube to vibrate reciprocally along a direction not parallel to the axis of the light guide tube. The vibration element controls the light guide tube to perform swift, reciprocal and high-frequency vibration to destroy coherence of the laser beam. Thus the laser beam can be output uniformly to avoid laser speckles caused by light interference.

### FIELD OF THE INVENTION

The present invention relates to a laser apparatus, particularly to an apparatus and a method for reducing laser speckle.

### BACKGROUND OF THE INVENTION

Owing to the environmental protectionism, it has been a trend to use laser as a backlight source. Laser light sources are environment-friendly (free of lead and mercury), easy to light up instantly, and ignitable at low temperature. Further, laser light sources operate at low voltage, respond fast, and emit high-directivity coherent light. FWHM (Full Width at Half Maximum) of laser beam is smaller than 1 nm, which is far smaller than 50 nm of LED light In chromatic performance, laser beam has higher color purity that is more saturate and sharp than LED light. With maturation of the three primary colors (RGB), laser display technology is expected to emerge soon.

A laser beam is a coherent, high-directivity and high-energy density light source, having a single wavelength/frequency and an identical phase. However, a laser light source is likely to suffer from laser speckles. During transmission, laser beam is likely to have interference because of dust in the air and the rough surface of the illuminated object. Constructive interference and destructive interference respectively generate bright speckles and dark speckles, which are distributed randomly and reflected to human eyes or the receiving devices. Thus, the image quality is affected.

One approach to overcome laser speckles is using the optical diffuser which has a rough surface for destroying the wavefront and the spatial coherence of a laser beam. After a laser beam passes through the irregular surface of the optical diffuser, the initial phase is converted into irregularly distributed phases. For example, optical diffusers are used to reduce laser speckles in a US Publication No. 20070097371 titled as “Laser Sensing Apparatus and Method” and a U.S. Pat. No. 6,594,090 titled as “Laser Projection Display System”. However, the high roughness of an optical diffuser would greatly attenuate the intensity of a laser beam.

Another approach to reduce laser speckles is using the microlens array. The microlenses are regularly arranged into an array. After a laser beam passes through a regular microlens array, the initial phase is converted into regularly distributed phases. The microlenses can be arranged to achieve uniformly scattered light. For example, microlens arrays are used to reduce laser speckles in a US Publication No. 20120081786 titled as “Laser Speckle Reduction Element” and a U.S. Pat. No. 6,081,381 titled as “Apparatus and Method for Reducing Spatial Coherence and for Improving Uniformity of a Light Beam Emitted from a Coherent Light Source”. Limited by the fabrication process, a microlens array is hard to achieve the same roughness in the surface and structure as an optical diffuser. Thus, the speckle-reducing effect of a microlens array is inferior to that of an optical diffuser. Besides, a microlens array is more complicated than an optical diffuser in structure and thus has a higher fabrication cost. Therefore, the field concerned is eager to develop a simple and low-cost apparatus and method to reduce laser speckles.

### SUMMARY OF THE INVENTION

The primary objective of the present invention is to overcome the intensity attenuation of the laser beam caused by optical diffusers and improve the complicated structure of the conventional apparatus for reducing laser speckle.

To achieve the above-mentioned objective, the present invention proposes an apparatus for reducing laser speckle, which cooperates with a laser light source and comprises a light guide tube and a vibration element coupled on the light guide tube. The light guide tube includes an input member corresponding to the laser light source, an output member far away from the laser light source, and a chamber allowing a laser beam which is emitted by the laser light source to perform total reflection inside. The vibration element is arranged at a region between the input member and the output member to drive the light guide tube to vibrate reciprocally along a direction not parallel to the axis of the light guide tube.

The present invention also proposes a method for reducing laser speckles, which cooperates with a laser light source and comprises the steps as follows:

Step S1: aligning an input member of a light guide tube to a laser light source and coupling a laser beam emitted by the laser light source to the light guide tube;

Step S2: letting the laser beam perform total reflection inside a chamber of the light guide tube and move toward one side of the light guide tube, which is far away from the input member;

Step S3: using a vibration element coupled on the light guide tube to drive the light guide tube to vibrate reciprocally along a direction not parallel to the axis of the light guide tube; and

Step S4: obtaining a uniform laser beam at an output member of the light guide tube, which is far away from the input member.

The present invention is characterized in:

1. The vibration element cooperates with the light guide tube to make the laser beam entering the light guide tube to perform total reflection in non-constant paths, whereby the coherence of the laser beam is destroyed.
2. The present invention overcomes laser speckles merely by using the light guide tube and the vibration element. Therefore, the present invention has advantages of simple structure and low cost.

### BRIEF DESCRIPTION OF THE DRAWINGS

FIG. 1 schematically shows an apparatus for reducing laser speckle according to a first embodiment of the present invention;

FIG. 2 schematically shows an apparatus for reducing laser speckle according to a second embodiment of the present invention;

FIG. 3 is a sectional view schematically showing a chamber of a light guide tube according to one embodiment of the present invention;

FIG. 4 shows a flowchart of a method for reducing laser speckles according to one embodiment of the present invention; and

FIG. 5 shows the relationships between laser speckle contrasts and vibration frequencies of different Curves according to one embodiment of the present invention.

### DETAILED DESCRIPTION OF THE PREFERRED EMBODIMENTS

The technical contents of the present invention are described in detail in cooperation with the drawings below.

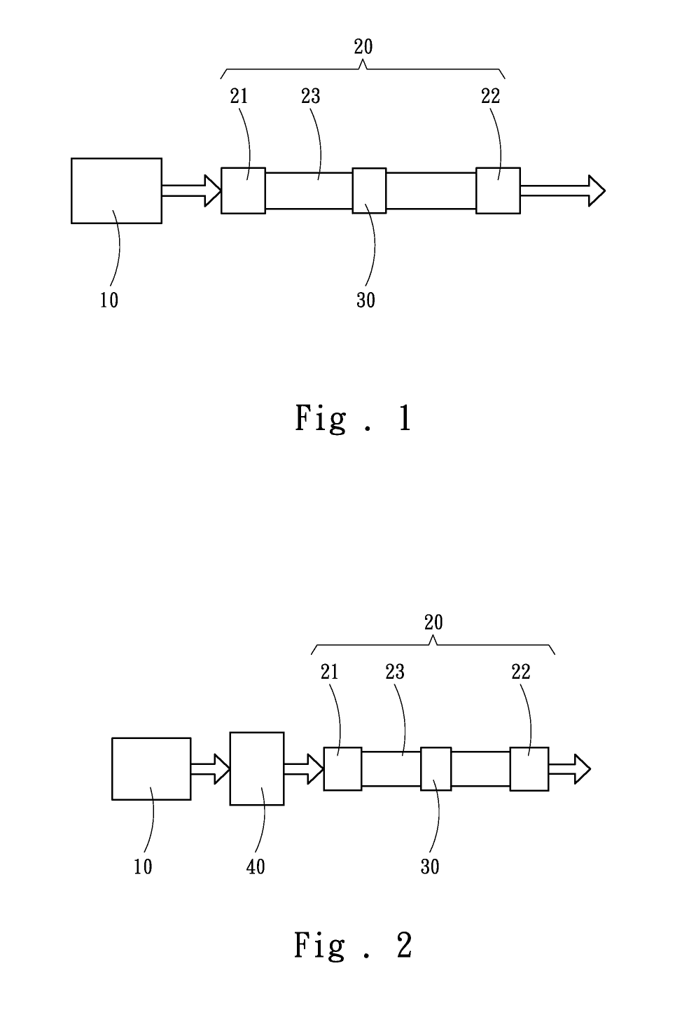

Refer to FIG. 1 schematically showing an apparatus for reducing laser speckle according to a first embodiment of the present invention. The apparatus for reducing laser speckle of the present invention cooperates with a laser light source 10 and comprises a light guide tube 20 and a vibration element 30 coupled on the light guide tube 20. The light guide tube 20 includes an input member 21 corresponding to the laser light source 10, an output member 22 far away from the laser light source 10, and a chamber 23 allowing a laser beam which is emitted by the laser light source 10 to perform total reflection inside. The vibration element 30 is coupled on the light guide tube 20 at a region between the input member 21 and the output member 22 to drive the light guide tube 20 to vibrate reciprocally along a direction not parallel to the axis of the light guide tube 20. The vibration frequency of the vibration element 30 is not less than 10 Hz, and the vibration amplitude of the vibration element 30 is not less than 0.1 mm. The limiting angle of resolution for human eyes is one angular minute. While the view angle of human eyes for an object is smaller than one an angular minute, human eyes can no more distinguish the details of the object. In such a case, the image of the object on the retina is as large as a photoreceptor cell, and the object looks like a single point. For human beings, LDDV (Least Distance of Distinct Vision) is 25 mm. Therefore, the minimum distance between two points distinguishable by human eyes is 0.1 mm. Owing to the above-mentioned facts, the vibration element 30 is controlled to have a vibration frequency of not less than 10 Hz and a vibration amplitude of not less than 0.1 mm.

It should be noted that while the vibration element 30 vibrates the light guide tube 20, the input member 21 and the output member 22 must be fixed lest the position where the laser beam enters the input member 21 is affected to result in intensity loss of the light when outputting via the output member 22. In the present invention, as the laser beam emitted by the laser light source 10 performs total reflection inside the chamber 23 of the light guide tube 20, and the vibration element 30 vibrates the light guide tube 20 reciprocally, the light guide tube 20 is slightly moved to randomly change the reflection angle as well as the transmission path of the laser beam inside the light guide tube 20. Consequently, after the coherence of the laser beam is destroyed, interference would not take place any more, thus the laser speckles can be effectively reduced.

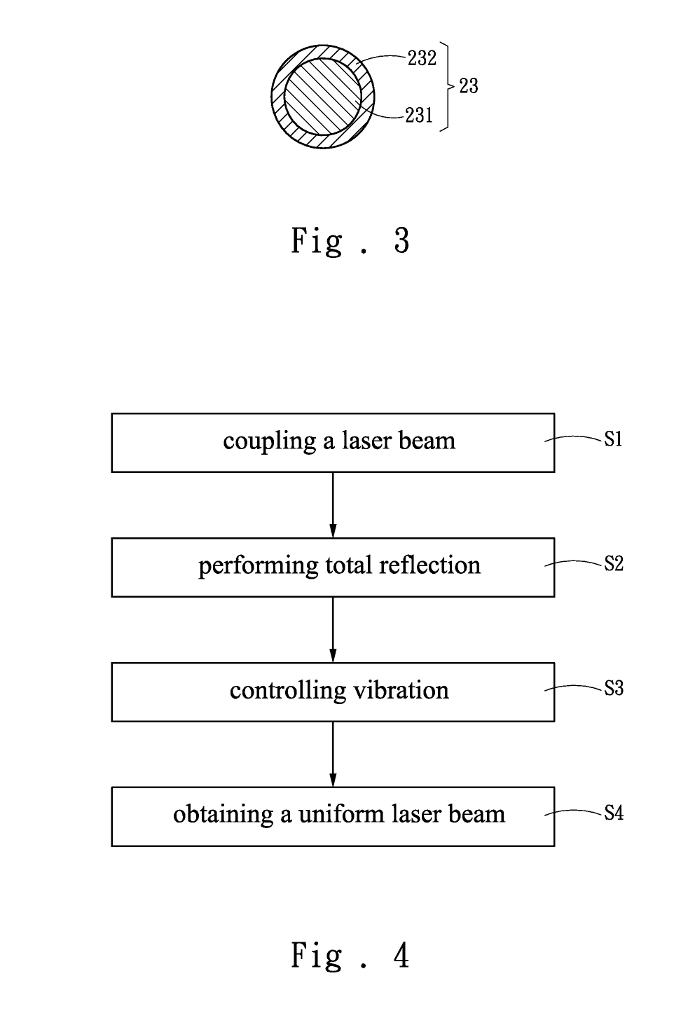

Refer to FIG. 2 schematically showing an apparatus for reducing laser speckle according to a second embodiment of the present invention. In order to increase the number of total reflection of the laser beam inside the light guide tube 20 and enhance the uniform effect, a light coupler 40 is arranged between the laser light source 10 and the input member 21 of the light guide tube 20 to make the laser beam enter the light guide tube 20 at an angle closer to the critical angle of the light guide tube 20. Alternatively, the light guide tube 20 also can be lengthened to increase the number of total reflection of the laser beam inside the light guide tube 20. Refer to FIG. 3 a sectional view of the chamber of the light guide tube according to one embodiment of the present invention. In this embodiment, the chamber 23 of the light guide tube 20 includes a light transmission medium 231 and a cover layer 232 wrapping the light transmission medium 231. The light transmission medium 231 is made of glass. The cover layer 232 is made of flexible stainless steel.

The present invention also proposes a method for reducing laser speckles. Refer to FIG. 4 showing a flowchart of a method for reducing laser speckles according to one embodiment of the present invention. The method of the present invention comprises Steps S1-S4.

Step S1—coupling a laser beam: Align an input member 21 of a light guide tube 20 to a laser light source 10 and couple a laser beam emitted by the laser light source 10 to the light guide tube 20. Alternatively, a light coupler 40 is arranged between the laser light source 10 and the light guide tube 20 for coupling the laser beam to enter the light guide tube 20, thereby the angle of the laser beam entering the light guide tube 20 is increased.

Step S2—performing total reflection: The laser beam performs total reflection inside a chamber 23 of the light guide tube 20 and moves toward one side of the light guide tube 20, which is far away from the input member 21. If a light coupler 40 is used, the angle between the laser beam and the axis of the light guide tube 20 is increased. Thus, the number of total reflection is also increased. Alternatively, the number of total reflection can also be increased via lengthening the light guide tube 20. Thereby is uniformed the laser beam.

Step S3—controlling vibration: Use a vibration element 30 coupled on the light guide tube 20 to drive the light guide tube 20 to vibrate reciprocally along a direction not parallel to the axis of the light guide tube 20 The vibration element 30 is controlled to have a vibration frequency of not less than 10 Hz and a vibration amplitude of not less than 0.1 mm.

Step S4—obtaining a uniform laser beam: Obtain a uniform laser beam at an output member 22 of the light guide tube 20, which is far away from the input member 21.

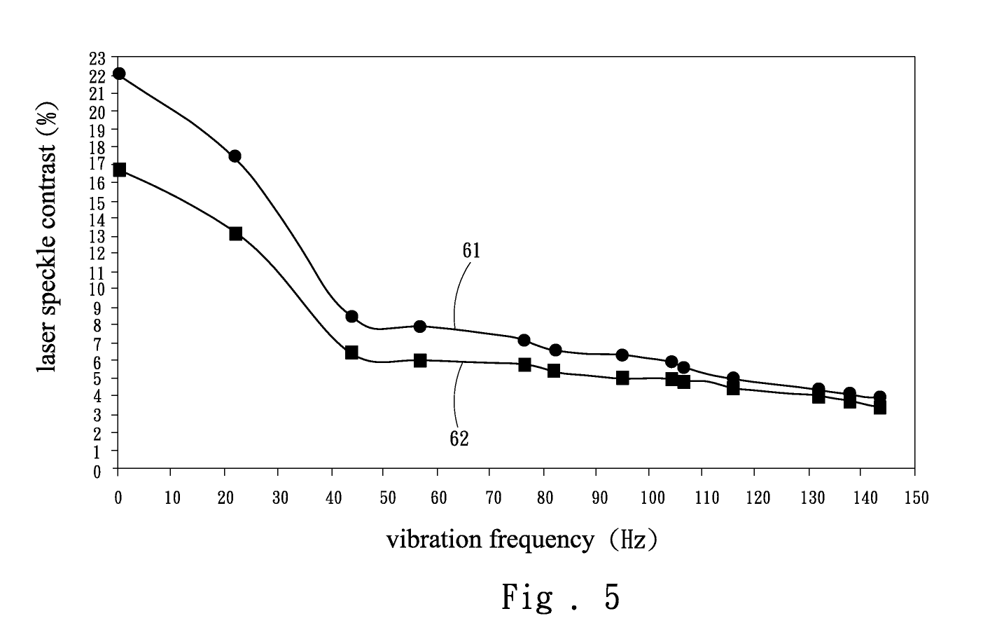

Refer to FIG. 5 showing Curve 61 of a first experiment group and Curve 62 of a second experiment group. In the first experiment group, the light coupler 40 is controlled to have a light diffusion angle of 23.57 degrees. In the second experiment group, the light coupler 40 is controlled to have a light diffusion angle of 40.54 degrees. The laser beam passing through the light coupler 40 is completely coupled to the light guide tube 20. The measurements prove that the intensity of the laser beam obtained at the output end is 72.55% of the original intensity of the laser beam. In this example, the light guide tube 20 has a length of 400 mm, and both the input end and the output end have a diameter of 6 mm. The data of the output laser beams is analyzed and compared. In the experiments, the vibration frequency of the vibration element 30 is increased from 0 to 143.5 Hz, and the vibration amplitude is also increased from 0 to 0.26 mm with the increase of the vibration frequency. The laser speckle contrast is used to evaluate the influence of laser speckles. The higher the laser speckle contrast, the greater the influence of laser speckles. As shown in FIG. 5, the laser speckle contrast in Curve 61 of the first experiment group that has a smaller light diffusion angle is greater than that in Curve 62 of the second experiment group that has a larger light diffusion angle. In the second experiment group, the larger light diffusion angle makes the laser beam have a greater number of total reflection and thus has higher capability of destroying the coherence of the laser beam. Therefore, the laser beam is more uniform and less influenced by laser speckles in the second experiment group. FIG. 5 also shows that the contrast of laser speckles is obviously decreased with the increase of the vibration frequency in both Curve 61 of the first experiment group and Curve 62 of the second experiment group. It means that the randomness of the total reflection of the laser beam inside the light guide tube 20 is increased with the vibration frequency to reduce laser speckle uniformly. While the vibration frequency is higher than 140 Hz, the laser speckle contrasts of Curve 61 and Curve 62 approximate to each other and decline slowly. It indicates that increase of the vibration frequency no more affects the laser speckle contrasts while the vibration frequency is over 140 Hz. As shown in FIG. 5, while the vibration frequency of the second experiment group is 143.5 Hz, the laser speckle contrast decreases to 3.46%, which is beyond the perceptibility of human eyes and thus meets practical requirement.

In conclusion, the present invention is characterized in

1. The vibration element cooperates with the light guide tube to make the laser beam entering the light guide tube to perform total reflection in non-constant paths, whereby the coherence of the laser beam is destroyed.
2. The present invention overcomes laser speckles merely by using the light guide tube and the vibration element. Therefore, the present invention has advantages of simple structure and low cost.
3. The light coupler increases the angle of the laser beam entering the input member and thus increases the number of total reflection of the laser beam inside the light guide tube. Thereby is enhanced the capability of destroying the coherence of the laser beam and increased the uniformness thereof.

What is claimed is:

1. An apparatus for reducing laser speckle, cooperating with a laser light source and comprising:
a light guide tube including an input member corresponding to the laser light source, an output member far away from the laser light source, and a chamber allowing a laser beam which is emitted by the laser light source to perform total reflection inside; and
a vibration element coupled on the light guide tube at a region between the input member and the output member to drive the light guide tube to vibrate reciprocally along a direction not parallel to an axis of the light guide tube.

2. The apparatus for reducing laser speckle according to claim 1, wherein the vibration element is controlled to have a vibration frequency of not less than 10 Hz and a vibration amplitude of not less than 0.1 mm.

3. The apparatus for reducing laser speckle according to claim 1 further comprising a light coupler arranged between the laser light source and the input member of the light guide tube for coupling the laser beam.

4. The apparatus for reducing laser speckle according to claim 1, wherein the chamber includes a light transmission medium and a cover layer wrapping the light transmission medium.

5. The apparatus for reducing laser speckle according to claim 4, wherein the light transmission medium is made of glass, and wherein the cover layer is made of flexible stainless steel.

6. A method for reducing laser speckles, cooperating with a laser light source and comprising the steps of:
Step S1: aligning an input member of a light guide tube to the laser light source and coupling a laser beam emitted by the laser light source to the light guide tube;
Step S2: letting the laser beam perform total reflection inside a chamber of the light guide tube and move toward one side of the light guide tube, which is far away from the input member;
Step S3: using a vibration element coupled on the light guide tube to drive the light guide tube to vibrate reciprocally along a direction not parallel to an axis of the light guide tube; and
Step S4: obtaining a uniform laser beam at an output member of the light guide tube, which is far away from the input member.

7. The method for reducing laser speckles according to claim 6, wherein in the Step S3, the vibration element is controlled to have a vibration amplitude of not less than 0.1 mm.

8. The method for reducing laser speckles according to claim 6, wherein the vibration element is controlled to have a vibration frequency of not less than 10 Hz.

9. The method for reducing laser speckles according to claim 6, wherein in the Step S1, a light coupler is arranged between the laser light source and the light guide tube for coupling the laser beam to enter the light guide tube.
